(19) United States
(12) Patent Application Publication
(10) Pub. No.: US 2025/0384345 A1
(43) Pub. Date: Dec. 18, 2025

(54) INITIALIZING CONTEXTUAL MULTI-ARMED BANDITS USING LARGE LANGUAGE MODELS

(71) Applicant: Royal Bank of Canada, Toronto (CA)

(72) Inventors: Parand Alizadeh Alamdari, Toronto (CA); Yanshuai Cao, Toronto (CA); Kevin H. Wilson, Toronto (CA)

(21) Appl. No.: 19/238,104

(22) Filed: Jun. 13, 2025

Related U.S. Application Data
(60) Provisional application No. 63/660,338, filed on Jun. 14, 2024.

(51) Int. Cl. G06N 20/00

(52) U.S. Cl. CPC G06N 20/00

(57) ABSTRACT

Large language models (LLMs) are used to pre-train contextual multi-armed bandits. LLMs, which are trained on extensive corpora, preserve a repository representative of certain human behavior and preferences and can serve as a booster for training a contextual multi-armed bandit. An LLM is used to generate synthetic users and associated data, and then the LLM is used for simulated interactions of those synthetic users with the contextual multi-armed bandit. The resulting dataset is then used to pre-train the contextual multi-armed bandit.

### CROSS-REFERENCE TO RELATED APPLICATION

This application claims priority to, and the benefit of, U.S. Provisional Application No. 63/660,338 filed on Jun. 14, 2024, the teachings of which are hereby incorporated by reference.

### TECHNICAL FIELD

The present disclosure relates to machine learning, and more particularly to pre-training of contextual multi-armed bandit frameworks in machine learning.

### BACKGROUND

One aspect of machine learning is directed to the provision of tailored content. When users encounter content that matches their needs and preferences, they are more inclined to engage and take a desired action, e.g., watch a movie (Amat et al., 2018) or click on a news article (Li et al., 2010). But how should content be personalized?Would a user be more likely to respond if the content was presented in a formal or informal style (Linos et al., 2024)? Or if it included a celebrity endorsement (Kreps et al., 2020)? These questions are deeply studied in behavioral economics (Thaler et al., 2019, Epstein et al., 2022), and that literature has proven that the answers can be heavily context-dependent (compare, e.g., Dai et al., 2021, Rabb et al., 2022).

In the machine learning context, contextual multi-armed bandits (Li et al., 2010 and Chu et al., 2011, each of which is incorporated herein by reference) were developed to address this problem in the sequential setting—where an agent is presented with the users in a sequence, chooses a piece of content to show the user based on the user's features and the content's features, and collects feedback essentially instantaneously. While these agents are known to exhibit good asymptotic performance, their initial choices are essentially random. To improve initial performance, researchers have focused on warm starting a contextual multi-armed bandit (Zhang et al., 2019) using detailed records of users' past behaviours and preferences in similar campaigns. However, collecting such datasets poses significant challenges due to resource demands, data diversity requirements, and the need to comply with privacy regulations.

### SUMMARY

The present disclosure describes the use of large language models (LLMs) to pre-train contextual multi-armed bandits. LLMs, which are trained on extensive corpora, preserve a repository that is representative of certain human behavior and preferences and can serve as a booster for training a contextual multi-armed bandit. An LLM is used to generate synthetic users and associated data, and then used for simulated interactions of those synthetic users with the contextual multi-armed bandit. The resulting dataset is then used to pre-train the contextual multi-armed bandit.

In one aspect, a computer-implemented method for initializing a contextual multi-armed bandit framework is provided. The method comprises prompting a trained large language model (LLM) to generate a plurality of synthetic users each having a respective context, wherein each context comprises respective specified values for a plurality of features for the respective synthetic user, specifying a plurality of arms for a contextual multi-armed bandit, and using the LLM and the contexts of the respective synthetic users to pre-train the contextual multi-armed bandit.

In some embodiments, using the LLM and the contexts of the respective synthetic users to pre-train the contextual multi-armed bandit may comprise, for each one of at least a subset of the synthetic users, over at least one iteration, prompting the LLM to use the context to pretend to be that one of the synthetic users and to select a preferred arm, wherein for each arm in the plurality of arms, a reward for that arm and that user is calculated using a number of times the LLM pretending to be that one of the synthetic users selects that arm. Preferably, the at least one iteration is a plurality of iterations.

In some embodiments, prompting the LLM to use the context to pretend to be that one of the synthetic users and to select a preferred arm for each ordered set may comprise prompting the LLM to select from an ordered pair of the arms.

In some embodiments, the context of each user may be a textual embedding of the respective specified values.

In some embodiments, the respective specified values may include at least one of age, gender, location, occupation, hobbies, and previous activities.

In some embodiments, the arms are specific to respective ones of the synthetic users.

In such embodiments, features of the arms may be generated using the LLM based on the respective contexts of the respective ones of the synthetic users. In other embodiments, the arms may be fixed for all users.

In another aspect, a computer program product comprises at least one tangible, non-transitory computer-readable medium embodying instructions which, when executed by at least one processor of a data processing system, cause the data processing system to implement any of the above-described methods.

In a further aspect, a data processing system comprises memory and at least one processor coupled to the memory, wherein the memory contains instructions which, when executed by the at least one processor, cause the at least one processor to implement any of the above-described methods.

### BRIEF DESCRIPTION OF THE DRAWINGS

These and other features will become more apparent from the following description in which reference is made to the appended drawings wherein:

FIG. 1 is a schematic overview of an illustrative computer-implemented method for initializing a contextual multi-armed bandit framework using at least one LLM according to an aspect of the present disclosure;

FIG. 2 is a flow chart showing an illustrative computer-implemented method for initializing a contextual multi-armed bandit framework using at least one LLM according to an aspect of the present disclosure;

FIG. 2A is a flow chart showing an illustrative method for using an LLM and the context of synthetic users to pre-train a contextual multi-armed bandit;

FIG. 3 is a graph showing regret outcomes for application of a contextual multi-armed bandit to true user data after being pre-trained using various LLMs; and

FIG. 4 is a block diagram showing an illustrative computer system in respect of which aspects of the present technology may be implemented.

### DETAILED DESCRIPTION

The present disclosure describes the integration of large language models (LLMs) with a contextual multi-armed bandit framework. Contextual multi-armed bandit frameworks have been widely used in recommendation systems to generate personalized suggestions based on user-specific context.

While initial performance for a contextual multi-armed bandit can potentially be improved by initializing the contextual multi-armed bandit using detailed records of users' past behaviors and preferences, collecting these datasets poses significant challenges in terms of costs and logistics, as well as raising potential privacy compliance issues. Suitably trained large language models (LLMs) offer a solution to this conundrum, since an LLM that is well-trained on extensive corpora can serve as a booster for training bandits. More particularly, LLMs, pre-trained on extensive corpora rich in human knowledge and preferences, can serve as an initialization tool for contextual multi-armed bandit algorithms. Leveraging a properly trained LLM's reflection of human behavior and preferences enables the LLM to generate a synthetic dataset of relevant human interactions. This dataset serves as a well-informed starting point for a contextual multi-armed bandit, which may reduce data gathering costs for pre-training such models.

### Overview of Contextual Multi-Armed Bandits

For T∈ [symbol] , let [T]={1, 2, . . . , T}. In a multi-armed bandit problem, there is an agent (the “bandit”) which must make a sequence of decisions at times t∈[T]. At each step t∈[T], the agent is presented with a set of K possible arms and must choose an arm kₜ, after which the agent receives a reward r_{t,k}_{ₜ} drawn from a reward distribution R(kₜ), which is initially unknown. The term “multi-armed bandit” is derived from a comparison to slot machines, known as “one-armed bandits”, and therefore in the multi-armed bandit framework, selecting an arm is sometimes referred to colloquially as “pulling” an arm. In the stochastic setting, each r_{t,k} is sampled independently from R(k) and the set of arms is fixed across all times [T]. The goal of the agent is to maximize the total reward

$${\sum }_{t = 1}^{T} {r}_{t , {k}_{t}} .$$

To achieve this, the agent needs to balance the tradeoff between exploration (i.e., trying different arms to gather more information about their reward distribution) and exploitation (i.e. choosing among the arms that appear to offer highest reward based on the information collected so far).

For contextual multi-arm bandits, at each time step t∈[T], the agent receives additional information ϕₜ∈ [symbol] referred to as the “context”. The reward distribution of selecting arm k∈[K] at time t may be different given the context ϕₜ, that is, r_{t,k}˜Rₖ(k,ϕₜ).

A policy w is a map from histories Hₜ=(ϕ₁, k₁, r₁, k₁, . . . ϕₜ₋₁, kₜ₋₁, r_{t1,k-1},ϕₜ) of contexts, arms, and realized rewards to the next arm π(Hₜ)=k the agent will choose.

The (cumulative) regret after T steps due to the agent choosing policies based on a policy w relative to a policy π* is given by

$$r e {g}_{π , {π}^{*}} = 𝔼 [ {\sum }_{t = 1}^{T} {r}_{t , {k}_{t}^{*}} ] - 𝔼 [ {\sum }_{t = 1}^{T} {r}_{t , {k}_{t}} ]$$

where kₜ is chosen according to π and

$${k}_{t}^{*}$$

is chosen according to π* and the expectations are taken with respect to any randomness in the rewards, contexts, and policy.

Some applications may consider the “sleeping bandits” approach, where at time t, the agent may choose between a subset of arms [symbol] ⊆[K] (Kleinberg et al., 2010). In this case, the contextual multi-armed bandit algorithm needs to learn and determine which arms yield the best reward when they are available.

### Integration of LLMs and Contextual Multi-Armed Bandits

LLMs trained on extensive corpora rich in human knowledge preserve the capacity to perform well on a diverse array of tasks, even those dependent on human behavior and preferences (Brown et al., 2020). In the context of personalization, LLMs can be utilized to automatically design user-specific content in large volumes. LLMs can also be used to simulate human interactions and predict their preferences, effectively serving as a proxy for collecting a dataset of users' interactions. The present disclosure is focused on the latter and provides a framework to utilize LLMs to generate extensive artificial user interactions to later train contextual multi-armed bandit models.

### Problem Formulation

An illustrative problem is formulated using the contextual multi-armed bandit framework. Consider a set of n users, where the vector of features of each user i∈[n] is denoted by Xᵢ which is sampled from a population [symbol] . At each time step t, user uₜ is sampled from the set of n users. A user's context can be calculated using the mapping function ϕ: [symbol] where [symbol] is the context space. There are K different arms, each representing a potential recommendation for the user. For each user uₜ and arm k, there is a scalar rewardR(k, uₜ) following some unknown distribution; for brevity Rₜ is used hereafter. There is an optimal policy πₒ which chooses the optimal arm

$${k}_{t}^{*} = arg {max}_{k ∈ [ K ]} 𝔼 [ {R}_{t} ( k ) ]$$

at each time step. The objective is to optimize the following (expected, cumulative) regret:

$${π}^{*} = arg {min}_{π} {reg}_{π , {π}_{o}}$$

Following the standard treatment in stochastic contextual multi-arm bandits (Lattimore et al., 2020), a feature map ψ: [symbol] ×[K]→ [symbol] ^{d} jointly encodes context and arms (either all arms or just the available ones in sleeping bandits). Then reward is modeled using Rₜ= [symbol] ψₜ,θ [symbol] , where θ is the parameter to be learned over the course of T steps. In the experiments described herein, the LinUCB algorithm described in Chu et al. (2011) was adapted for training the contextual multi-armed bandits. From a cold start, this algorithm is should yield regret of Õ(\sqrt{Td}) where d is the dimension of the vector θ.

### Process Overview

The present disclosure describes a computer-implemented method for initializing a contextual multi-armed bandit framework using at least one LLM. One or more LLMs are used to generate a large and diverse dataset of synthetic users, with their (synthetic) interactions and their (synthetic) preferences. The one or more LLMs then use the synthetic dataset to create simulated interactions to pre-train a contextual multi-armed bandit model for use in a real setting. The pre-trained model serves as a starting point, and later is tuned with the data from real users' interactions as they are collected over time.

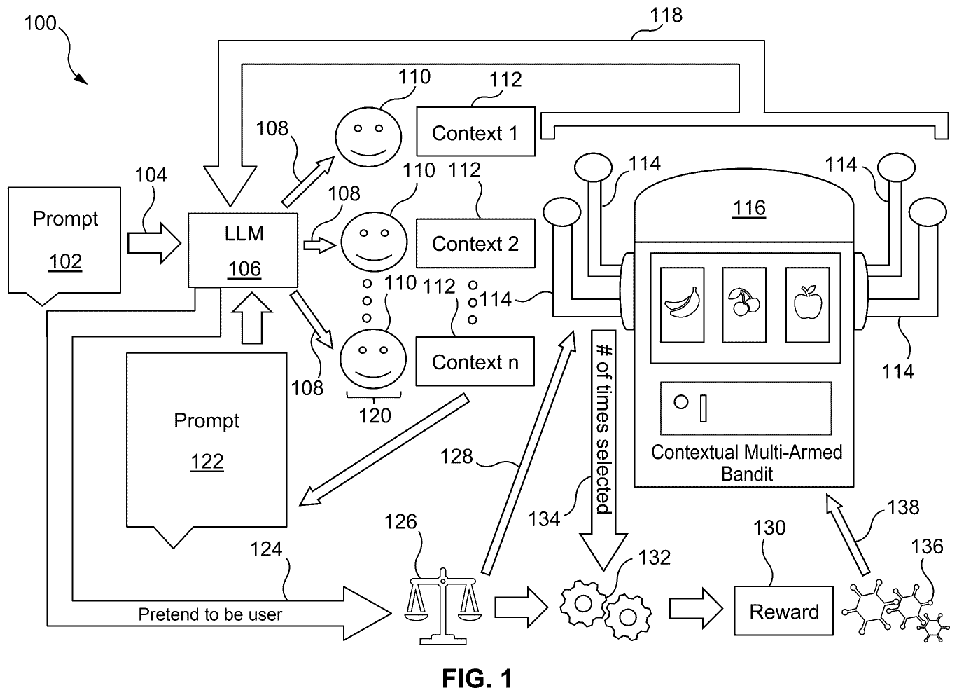

Reference is now made to FIG. 1, which is a schematic overview of an illustrative computer-implemented method 100 for initializing a contextual multi-armed bandit framework using at least one LLM according to an aspect of the present disclosure.

A first prompt 102 is provided 104 to a trained LLM 106 to generate 108 a plurality of synthetic users 110 each having a respective context 112. The term “synthetic”, as used herein, refers to simulation. Thus, the synthetic users 110 are simulations of users as represented by their respective contexts 112, which are also simulated. Thus, the synthetic users 110 and their contexts 112 are preferably generated ex nihilo by the LLM 106, rather than representing masking of actual real world users, or mixtures or scrambles of real world users. The LLM 106 may be, for example, any of the OpenAI offerings (see https://platform.openai.com/docs/models), Claude-3 Haiku (Anthropic, 2024), and Mistral-Small (see https://mistral.ai/), among others. Each context 112 comprises respective specified values for a plurality of features for the respective synthetic user 110. The specified values may include one or more of age, gender, location, occupation, hobbies, and previous activities of the respective synthetic users 110. The context 112 of each user 110 may be, for example, a textual embedding of the respective specified values, although other representations are also contemplated.

A plurality of arms 114 are specified for a contextual multi-armed bandit 116. This may be done either before or after the synthetic users 110 are generated 108. In a preferred embodiment, the arms 114 are specified after the synthetic users 110 are generated 108 and the arms 114 are specific to respective ones of the synthetic users 110. Optionally, features of the arms 114 may be generated using the LLM 106 based on the respective contexts 112 of the respective ones of the synthetic users 110. In other embodiments, the arms 114 may be fixed for all users 110.

The method 100 uses the LLM 106 and the contexts 112 of the synthetic users 110 to pre-train the contextual multi-armed bandit 116. In one illustrative embodiment, the arms 114 of the contextual multi-armed bandit 116 are provided 118 to the LLM 106. The LLM 106 is prompted 122 to use the context 112 to pretend 124 to be that one of the synthetic users 110 and to select 126 a preferred 128 arm 114 at least once (one iteration) for each one of the users 110 in the subset 120, and preferably over a plurality of iterations (e.g. 5 or more iterations for each synthetic user 110 in the subset 120). Because the LLM 106 includes probabilistic aspects, a plurality of iterations is preferred, preferably at least five iterations. Although shown separately for simplicity of illustration, the arms 114 of the contextual multi-armed bandit 116 may be provided to the LLM 106 as part of prompting 122 LLM 106. Also in a preferred embodiment, prompting 122 the LLM 106 to use the context 112 to pretend 124 to be that one of the synthetic users 110 and to select 126 a preferred 128 arm 114 comprises prompting 122 the LLM 106 to select from an ordered pair of the arms 114.

For each arm 114 in the plurality of arms 114, a reward 130 for that arm 114 and that user 110 is calculated 132 using the number of times 134 the LLM 106 pretending to be that one of the synthetic users 110 selects that arm 114. A reward distribution can then be estimated 136 and used for pre-training 138 the contextual multi-armed bandit 116.

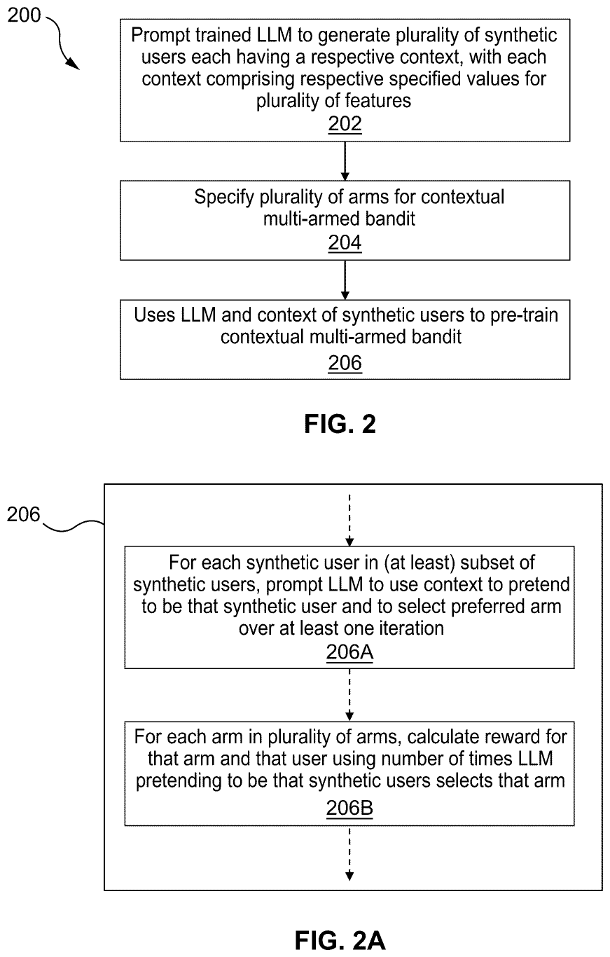

Reference is now made to FIG. 2, which is a flow chart showing an illustrative computer-implemented method 200 for initializing a contextual multi-armed bandit framework using at least one LLM.

At step 202, the method 200 prompts a trained large language model (LLM) to generate a plurality of synthetic users each having a respective context, with each context comprising respective specified values for a plurality of features (e.g. one or more of age, gender, location, occupation, hobbies, and previous activities) for the respective synthetic user. The context of each user may be a textual embedding of the respective specified values, or may be specified in another way.

At step 204, the method 200 specifies a plurality of arms for a contextual multi-armed bandit. Step 204 may be performed before or after step 202. In a preferred embodiment, step 204 is performed after step 202 as shown in FIG. 2, and the arms are specific to respective ones of the synthetic users. Still more preferably, at step 204 the features of the arms are generated using the LLM based on the respective contexts of the respective ones of the synthetic users. In other embodiments, the arms specified at step 204 may be fixed for all users.

At step 206, the method 200 uses the LLM and the context of the synthetic users to pre-train the contextual multi-armed bandit.

Reference is now made to FIG. 2A, which is a flow chart showing an illustrative implementation of step 206 of the method 200 shown in FIG. 2; that is, FIG. 2A shows sub-steps of step 206. Thus, FIG. 2A shows an illustrative method for using the LLM and the context of the synthetic users to pre-train the contextual multi-armed bandit. At sub-step 206A, for each one of at least a subset of the synthetic users, the LLM is prompted to use the context to pretend to be that one of the synthetic users and to select a preferred arm over at least one iteration, and preferably over a plurality of iterations. Preferably, sub-step 206A is carried out by prompting the LLM to select from an ordered pair of the arms. At sub-step 206B, for each arm in the plurality of arms, a reward for that arm and that user is calculated using the number of times the LLM pretending to be that one of the synthetic users selects that arm.

### Illustrative Implementation

An implementation may begin by setting up a contextual multi-armed bandit framework where the context is the information about each user as described above, First, n synthetic users are generated by sampling i.i.d. from feature space [symbol] . For each sampled synthetic user i, whose features are denoted by Xᵢ, a textual embedding [symbol] = [symbol] (Xᵢ)∈ [symbol] is computed in some language space [symbol] The exact function [symbol] is domain-dependent and can represent arbitrary side information about a user. For instance, a video streaming service might take Xᵢ to be the sequence of movies that the synthetic user i “watched” previously and transform it into a string “This user has watched the following movies: [Movie₁], [Movie₂], . . . ”. These textual embeddings may then be transformed into a context ϕ₁=ϕ( [symbol] ), for example using another LLM. The foregoing is merely one illustrative textual embedding, and is not limiting. Moreover, video streaming is merely one illustrative, non-limiting application. Aspects of the present disclosure may be applied to virtually any context in which a contextual multi-armed bandit framework may be deployed.

The K arms of the contextual multi-armed bandit represent the different options that might be offered to the users, or potential prompts to an LLM that will generate content to send to users. Thus, the arms can be personalized for each user using LLMs.

In one embodiment, to estimate the reward distribution for selecting each arm, given a user's context, for each synthetic user i (or at least each synthetic user i in a subset of the synthetic users), an LLM [symbol] is used to simulated the preferences of synthetic user i based on their textual representation [symbol] . Specifically, for each synthetic user i, the LLM [symbol] is prompted to adopt the persona of synthetic user i. To determine the reward distribution for different actions, in a preferred embodiment each pair of arms (k₁, k₂) within the set of K arms is considered, rather than the entire set K of arms being considered at once (assuming that K>2). Considering the entire set K of arms at once is less preferred (where K=2 then of course both arms must be considered at once). The LLM [symbol] is then prompted to indicate which arm the synthetic user i would prefer. Preferably, this process is repeated across multiple iterations times to get more instances of answers for each pair of arms and user. By aggregating these preferences across all pairs and users, the reward distribution for selecting each arm in the context of a given user can be estimated. The above-described illustrative implementation is shown algorithmically (Algorithm 1) below. In the case of a sleeping bandit or when the number of arms is large, the sparse mode in Algorithm 1, where only a random subset of pairs are sampled and pairwise preferences are stored, may be used.

Alternatively, Algorithm 1 iterates over all pairs of arms and records an absolute reward per each arm based on the number of winnings in pairwise comparisons.

Algorithm 1: Generate Synthetic Preferences

| 1: | Input: Specification of features of users, K arms, number of users n, an LLM | |
|---|---|---|
| | [symbol] , and is_sparse_mode | |
| 2: | U ← { }, R ← { } | |
| 3: | for i ∈ [n] do | |
| 4: | Sample user i i.i.d. from feature space [symbol] | |
| 5: | Embed user i to the context space as ϕᵢ | |
| 6: | Describe user i with text as [symbol] | |
| 7: | U ← U ∪ {ϕᵢ} | |
| 8: | if is_sparse_mode then | |
| 9: | Rᵢ ← [0]^{K×K} | [symbol] sparse matrix |
| 10: | A = Uniform([K] × [K]) | |
| 11: | else | |
| 12: | Rᵢ ← [0]^{K} | [symbol] vector |

| | |
|---|---|
| 13: | A = [K] × [K] |
| 14: | end if |
| 15: | Prompt [symbol] to adopt i's persona given [symbol] |
| 16: | for (k₁, k₂) ∈ A do |
| 17: | Prompt [symbol] to indicate user i's preference between k₁ and k₂ as |
| | P |
| 18: | if is_sparse_mode then |
| 19: | Rᵢ[k₁, k₂]+= [symbol] [k₁ == P] |
| 20: | else |
| 21: | Rᵢ[P]+= 1 |
| 22: | end if |
| 23: | end for |
| 24: | Normalize Rᵢ |
| 25: | R ← R ∪ {Rᵢ} |
| 26: | end for |
| 27: | Output: Users' Context: U, Rewards: R |

Of note, in a preferred embodiment the LLM [symbol] is prompted to rank pairs of arms as opposed to scoring arms individually and determining an ordering based on the individual scores. Without being limited by theory, it is believed that prompting the LLM [symbol] with pairs of arms leads to more consistent results compared to scoring each arm independently, and that prompting the LLM [symbol] with pairs of arms captures the diverse preferences of users more effectively, revealing distinct patterns in user preferences across different arms.

Also in a preferred embodiment, all pairs (k₁, k₂)∈[K]×[K] are evaluated (e.g. lines 10 and 13 of Algorithm 1) and not, for example, all pairs (k₁, k₂) with k₁<k₂, which should be sufficient to determine an ordering. However, it has been observed that LLMs are sensitive to the order in which options are presented (Santurkar et al., 2023), so preferably the average over both orders is taken to mitigate this potential bias.

Rᵢ[k] should approximate a rank ordering of per arm rewards and may not estimate the exact reward; this is sufficient for best arm identification. The rank ordering is suitable for applications in which the objective is to maximize total rewards, but caution should be exercised in other contexts, such as where contextual multi-armed bandits are used in adaptive treatment assignment with other goals or constraints (Bastani et al., 2021; Kasy et al., 2021). In Algorithm 1, for each user u and each pair of arms (k₁, k₂), an LLM [symbol] is prompted to rank the arms. If it ranks kᵢ higher than k₂, it can be said that Rᵤ[k₁]=Rᵤ[k₁]+1. Otherwise, it can be said that Rᵤ[k₂]=Rᵤ[k₂]+1. Under certain assumptions on the true rewards, the values Rᵤ will represent a rank order of the user's preferences. Assume that the reward distribution for user u and arm i is Yᵢ=Bern(pᵢ), a Bernoulli random variable with probability pᵢ of realizing 1 and probability 1−pᵢ of realizing 0. If pᵢ>pⱼ, then, on average, the user u will derive more reward from being assigned arm i than arm j. Consider the random variables

$${Z}_{ij} \{ \begin{matrix}1 & {Y}_{i} > {Y}_{j} \\ 0 & {Y}_{i} < {Y}_{j} \\ B & {Y}_{i} = {Y}_{j}\end{matrix}$$

where B=Bern(0.5) is a Bernoulli random variable with probability 0.5 of being 1 and probability 0.5 of being 0. Further, let Zᵢ=Σⱼ Zᵢⱼ. Then, assuming the LLM [symbol] faithfully represents the user's preferences, by the law of large numbers, it is expected the unnormalized Rᵤ[i]≈m [symbol] [Zᵢ] where m is the number of iterations. Now:

$$𝔼 [ {Z}_{i j} ] = Pr ( {Y}_{i} > {Y}_{j} ) + \frac{1}{2} \cdot Pr ( {Y}_{i} = {Y}_{j} ) = {p}_{i} ( 1 - {p}_{j} ) + \frac{1}{2} [ {p}_{i} {p}_{j} + ( 1 - {p}_{i} ) ( 1 - {p}_{j} ) ] = \frac{1}{2} ( {p}_{i} - {p}_{j} + 1 ) .$$

Then

$$𝔼 [ {Z}_{i} ] = \frac{K}{2} ( {p}_{i} + 1 ) - \frac{1}{2} {\sum }_{j} {p}_{j} .$$

Rewriting gives

$$𝔼 [ {Z}_{i} ] = \frac{K}{2} {p}_{i} + C$$

where C is a constant for all i. Thus, the [symbol] [Zᵢ] have the same order as the pᵢ.

The dataset of synthetic users and their corresponding rewards resulting from Algorithm 1 can then be used to pre-train a contextual multi-armed bandit using established algorithms that are known to those of ordinary skill in the art. Some non-limiting examples of such algorithms include those described in Li et al. (2010) and Chu et al. (2011). At each step t∈[T], a user uₜ and their associated context ϕₜ is sampled from the set of n synthetic users. In the usual setting, the contextual multi-armed bandit then chooses an arm at and receives reward Rₜ[kₜ]. In the sleeping bandit setting, the contextual multi-armed bandit will be presented with two arms (k₁, k₂) and will choose one to set as k₁ and the other as k₂. It will then receive reward Rₜ[k₁, k₂]. According to an aspect of the present disclosure, the (generated) Rₜ should always be available, unlike training from actual log data, where the user uₜ may not have been assigned to the desired arm.

The contextual multi-armed bandit training algorithm is followed to pre-train a contextual multi-armed bandit model, which serves as an informed baseline that can effectively guide real user interactions from the outset. Over time, the contextual multi-armed bandit model can be fine-tuned and adapted using real user data and interactions, enabling it remains responsive to evolving user preferences and behaviors.

Development of suitable prompts for the LLMs is within the capability of one of ordinary skill in the art, now informed by the present disclosure, as a matter of prompt engineering.

### Experimental Results

Choice-Based Conjoint Analysis with Real-World Data

The effectiveness of methods according to the present disclosure was evaluated using the results of a conjoint survey experiment. These experimental designs are popular in political science (Bansak et al., 2021), health (Trapero-Bertran et al, 2019) and market research (Cattin et al., 1982; Li et al., 2010), and are designed to detect how individuals value different characteristics of a candidate for public office, a health intervention, a product, or another item of interest. These items usually have multiple features, which features may be causally linked to preferences. A conjoint survey proceeds by showing descriptions of two or more items to a participant and asking the participant to rank the items according to some criterion, e.g., likelihood to purchase. This type of arrangement is suitable for testing methods according to the present disclosure because the survey experiments capture both user demographic information, which can be used to generate contexts, as well as information on human preferences, which can be the target of a contextual multi-armed bandit.

An experiment to evaluate methods according to the present disclosure was conducted based on the conjoint survey experiment described in Kreps et al. (2020), using the dataset provided in Kriner et al. (2020), both of which are incorporated herein by reference. This survey, conducted before the widespread availability of COVID-19 vaccines, attempted to determine which properties of a hypothetical vaccine would lead to wider acceptance of the vaccine.

The experiment adapted the LinUCB algorithm described in Chu et al. (2011) with a=10 as the hyperparameter. In the experiment, different LLM models (OpenAI GPT-4o (Achiam et al., 2023), GPT-3.5, Claude-3 Haiku (Anthropic. 2024), and Mistral-Small (Jiang et al., 2023)) were used as the LLM M. Data was collected using the respective LLM APIs. The contextual multi-armed bandit models were trained on a system with the following specification: 2.3 GHz Quad-Core Intel Core i7 and 32 GB of RAM. The total running time to train the models is less than 2 hours.

### Users and Setting

In the Kreps et al. (2020) study, N=1970 participants begin by providing demographic and personal information. Each respondent answered the following multi-choice questions: gender, race, age, state, income range, religious beliefs, political views, their (dis)approval of Donald Trump's handling of his job as president (survey taken in 2020), recent changes in employment status, ability to work from home, whether they suffered from COVID-19, if they knew a person who had been hospitalized or had died because of COVID-19, whether (with respect to COVID-19) they believed the worst was in the past or yet to come, whether they had received a flu vaccination in the past, whether they think vaccines are safe in general, whether they think children should be required to be vaccinated against childhood diseases, and whether they have health insurance. This information was used to represent the context vector of each user. Next, participants are presented with a pair of hypothetical COVID-19 vaccines and asked to express which they are more likely to accept. Each vaccine is characterized by a specific set of attributes: efficacy, duration of protection, major side effects, minor side effects, FDA approval, country of origin, and whether it is endorsed by a president or a health organization. The variations in these attributes resulted in 576 possible vaccine descriptions. This process (participants are presented with a pair of hypothetical COVID-19 vaccines and asked to express which they are more likely to accept) is repeated a total of five times per participant. A full description of the dataset is available at https://dataverse.harvard.edu/dataset.xhtml?persistentId=doi:10.7910/DVN/6BSJYP.

To train the model according to Algorithm 1 above, 10,000 synthetic users are generated, based on the set of features of the actual users. These synthetic users are used to pre-train the contextual multi-armed bandit. Given the large number of potential vaccine combinations, the approach used to evaluate methods according to the present disclosure was adapted by not considering every possible vaccine as an individual arm. Instead, each vaccine, described by its set of features, is assumed to be sampled from a population [symbol] where |V| I 576 as there are 576 different vaccines in the dataset. At each step t∈T, user uₜ is randomly selected from the synthetic users. Subsequently, a pair of vaccines v₁, v₂∈ [symbol] is sampled. Rather than treating each vaccine as an arm, the focus is on the comparison between pairs of vaccines, which aligns more closely with how choices are presented in the conjoint analysis. For each user uₜ and a pair of vaccines v₁, v₂, the respective LLM is prompted with the following:
Consider you are in the middle of the COVID pandemic where vaccines are just being produced. Pretend to be the following user: [description of uₜ] now you are given two vaccine choices for COVID. The description of each vaccine is as follows: [description of v₁], now the next one: [description of v₂]. Which one do you take?A or B?Let's think step by step. Print the final answer as [Final Answer] at the end as well.

A feature map, ψ: [symbol] jointly encodes the user context ϕᵢ∈ [symbol] and the two vaccines vᵢ∈ [symbol] and v₂∈ [symbol] V, and then learns a linear model on ψ. In the experiment, ψ(ϕᵢ, v₁, v₂)=flat(ϕᵢ(f(v₁)−f(v₂))^{T}, where flat represents flattening a matrix of size n×m as a vector of size nm and f(v), f: [symbol] , outputs the 7 features of each vaccine in the dataset.

### Arms

The approach used to evaluate methods according to the present disclosure adopted a “sleeping bandit” framework as described in Kleinberg et al. (2010) and incorporated herein by reference. Unlike the traditional multi-armed bandit setting where all arms are assumed to be available at each step t, the sleeping bandit model relaxes this assumption by allowing only a subset of arms to be available at any given step. The experiment to evaluate methods according to the present disclosure simplified the availability to just two arms at each step t. These two arms represent the pair of vaccines presented in the context. Thus, at each decision point, the model must choose between only these two options. The present disclosure is not, however limited to the sleeping bandit model.

### Rewards

The sparse mode in Algorithm 1 above is used. For pre-training bandit data collection, for the pair of vaccines i, j, if the LLM-simulated synthetic user prefers i over j, then R[i,j]+=1. Rₜ for online learning from actual rewards at round t works similarly, but is based on real human preferences from the conjoint experiment log.

### Results

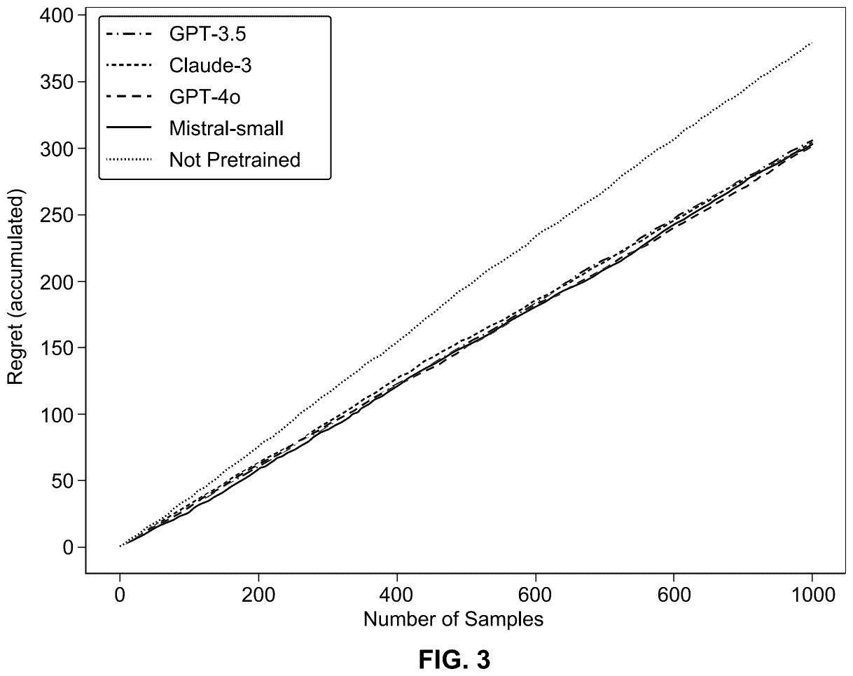

The impact of pre-training contextual multi-armed bandits using data generated by LLMs is illustrated in FIG. 3. In the experiment, different models (OpenAI GPT-4o (Achiam et al., 2023), GPT-3.5, Claude-3 Haiku (Anthropic. 2024), and Mistral-Small (Jiang et al., 2023)) were used as the LLM [symbol] to pre-train the contextual multi-armed bandit using data from 10,000 synthetic users and their (synhetic) preferences as simulated by the LLM [symbol] . Once pre-trained, the contextual multi-armed bandit was deployed for the real users participating in the study and further fine-tuned using their actual responses. FIG. 3 presents the regret outcomes for the various models when applied to true user data. Regret is computed based on the discrepancy between the model's recommendations and the actual preferences of the study participants. These results were compared against a baseline model, denoted as “Not Pretrained” in FIG. 3, which was trained exclusively on the real user data without any pre-training. FIG. 3 clearly shows that contextual multi-armed bandit models pre-trained with LLM-generated synthetic users exhibit significantly lower regret compared to the baseline contextual multi-armed bandit model that was not pre-trained (upper plot line). This demonstrates that using LLMs to simulate user preferences and pre-train contextual multi-armed bandit models can effectively reduce the learning curve and improve performance when transitioning to actual user interactions.

Table 1 below explores the effect of differing amounts of pre-training data. In this example more LLM-generated synthetic users improves the performance of the contextual multi-armed bandits, although with diminishing returns. The reduction in cumulative regret is measured after T=1000 steps of fine-tuning.

TABLE 1
The reduction in cumulative regret of T = 1000 steps
when pretraining a contextual multi-armed bandit with
100, 1,000, or 10,000 LLM-generated synthetic users and
their rewards (with input LLM [symbol] ) compared
to contextual multi-armed bandits with no pretraining

| | Users | | |
|---|---|---|---|
| [symbol] | 1000 | 5000 | 10000 |
| GPT-4o | 17.10% ± 0.63 | 16.07% ± 0.39 | 20.28% ± 0.41 |
| GPT-3.5 | 11.95% ± 0.67 | 14.32% ± 0.38 | 19.19% ± 0.53 |
| Claude-3 | 13.79% ± 0.58 | 17.18% ± 0.16 | 19.65% ± 0.37 |
| Mistral-small | 14.51% ± 0.77 | 17.89% ± 0.40 | 20.39% ± 0.38 |

Initializing Contextual Multi-Armed Bandits with Partial Information

To explore the robustness of methods according to the present disclosure, additional experiments were conducted to evaluate the impact of varying amounts of user information on the effectiveness of pre-training the contextual multi-armed bandit. Experiments were carried out with three distinct subsets of user data:
No Personal: This subset excludes any personal or demographic details about the users. It focuses solely on COVID-19 and vaccine-related information for each user.
Only Personal: This subset includes only the personal and demographic information of each user, such as age, gender, location, and income range. It omits any data related to COVID-19 or vaccines for each user.
Partial Personal: This subset contains a reduced set of personal and demographic details compared to the Only Personal subset. It includes a minimal amount of personal information, providing a middle ground between having comprehensive user profile and having none at all.
The Full dataset includes all of the information about the users, and was used as a baseline.

For each baseline, the total accumulated regret (calculated based on the true responses of users in the survey) was computed after T=1000, 2000 and 9855 steps using the responses of true users in the survey. T=9855 steps is fine tuning the model with all the data in the survey. The process begins by pre-training the contextual multi-armed bandit models using data from 10,000 synthetic users; all baselines are pre-trained with GPT-3.5 generated preferences of users. After pre-training, each contextual multi-armed bandit model is fine-tuned with data from actual users, using their survey responses. To evaluate the effectiveness of each approach, the accumulated regret for each baseline model is calculated. Improvement of regret is measured with respect to the regret of a contextual multi-armed bandit model that was not pre-trained and was only trained on real user data. The results, summarized in Table 2, demonstrate that incorporating even minimal user context during pre-training can significantly enhance the performance of contextual multi-armed bandit models. Furthermore, as the number of fine-tuning steps T increases, the reduction in cumulative regret for each pre-trained baseline gradually diminishes. This convergence occurs because, over time, the contextual multi-armed bandit model accumulates sufficient data from real users during the fine-tuning phase. As a result, the performance gap between the pre-trained models and the model that was not pre-trained becomes less pronounced.

TABLE 2
The reduction in accumulated regret when pre-training contextual
multi-armed bandit models with varying levels of user
information. Each row represents a different baseline,
with a different amount of user-specific context.

| | Users | | |
|---|---|---|---|
| Data | 1000 | 2000 | 9855 (all) |
| Full | 19.19% ± 0.53 | 14.90% ± 0.44 | 8.07% ± 0.22 |
| No Personal | 14.79% ± 0.41 | 11.60% ± 0.47 | 5.23% ± 0.15 |
| Partial Personal | 18.55% ± 0.51 | 14.81% ± 0.46 | 7.70% ± 0.19 |
| Only Personal | 15.25% ± 0.45 | 11.60% ± 0.47 | 7.69% ± 0.20 |

### Technical Effect

As can be seen from the above description, the integration of LLMs and contextual multi-armed bandits as described herein represent significantly more than merely using categories to organize, store and transmit information and organizing information through mathematical correlations. The integration of LLMs and contextual multi-armed bandits is in fact an improvement to the technology of machine learning, as this integration provides for the initialization (pre-training) of contextual multi-armed bandits without the need for real user data, which may improve initial performance of a contextual multi-armed bandit as compared to a “cold start” without initialization. Utilizing LLM-generated synthetic user data and their simulated preferences offers significant benefits. The technology described herein reduces storage and intake processing requirements associated with the collection and storage of initialization data for multi-armed bandits. In this way local compute cost is reduced. In particular, by generating synthetic user data and simulated preferences, the disclosed method improves resource use by obviating the need to maintain stores of real user data. Further, the disclosed method leverages the existing distillation of the data upon which the LLM was trained and avoids the need to acquire, store and manage data exclusively for the multi-armed bandit. The present technology not only reduces data storage and management costs but also lowers the costs associated with data collection and also mitigates privacy concerns, as it does not involve real user data. The integration of LLMs and contextual multi-armed bandits as described herein provides a cost-effective and privacy-preserving solution for training models in personalized systems. Further, aspects of the present disclosure enable contextual multi-armed bandit models pre-trained with LLM-generated synthetic users to exhibit significantly lower regret compared to baseline contextual multi-armed bandit models that were not pre-trained, as illustrated in FIG. 3 and Table 1. This demonstrates that using LLMs to simulate user preferences and pre-train contextual multi-armed bandit models can effectively reduce the learning curve and improve performance when transitioning to actual user interactions. Thus, the present disclosure is directed to the resolution of a computer problem, specifically how to initialize an improved multi-armed bandit with reduced computational resource. Moreover, the technology is confined to machine learning applications. Key features of the present disclosure describe and enable automation of the generation of synthetic user data and their simulated preferences and automation of the application of such synthetic user data and preferences. Importantly, however, the present disclosure is not directed merely to the automation of a manual process by generic computer processing of mathematical calculations, but describes specific functional computer technology that enables the automation. Furthermore, the human mind is not equipped to effectively generate a plurality of synthetic users each having a respective context, or use the contexts of the respective synthetic users to pre-train a contextual multi-armed bandit; these are activities that are unique to computers and by their very nature require computer implementation—they exist only in the context of a computer system. LLMs and multi-arm bandit training itself exists only in the context of operational computer systems and are inherently confined to machine learning applications.

### Technical Environment and Embodiment

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

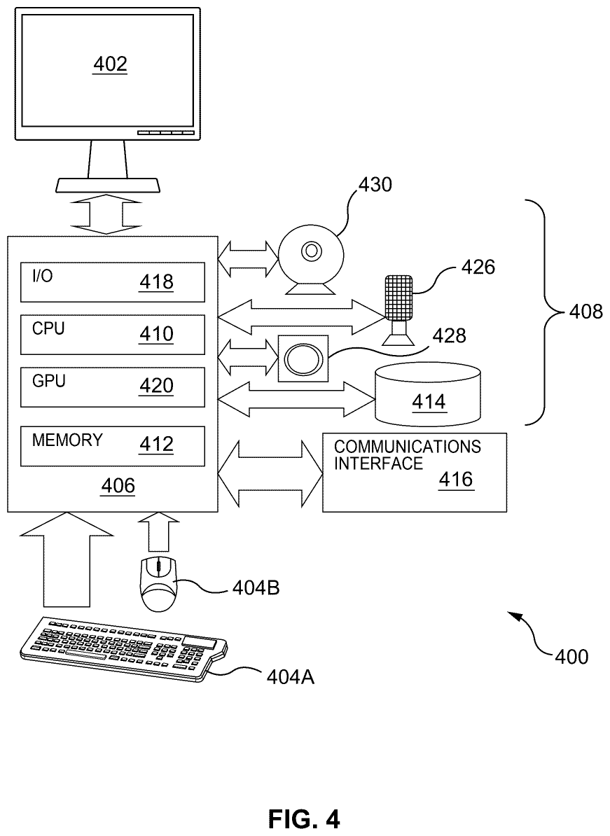

An illustrative computer system in respect of which the technology herein described may be implemented is presented as a block diagram in FIG. 4. The illustrative computer system is denoted generally by reference numeral 400 and includes a display 402, input devices in the form of keyboard 404A and pointing device 404B, computer 406 and external devices 408. While pointing device 404B is depicted as a mouse, it will be appreciated that other types of pointing device, or a touch screen, may also be used.

The computer 406 may contain one or more processors or microprocessors, such as a central processing unit (CPU) 410. The CPU 410 performs arithmetic calculations and control functions to execute software stored in an internal memory 412, preferably random access memory (RAM) and/or read only memory (ROM), and possibly additional memory 414. The additional memory 414 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 414 may be physically internal to the computer 406, or external as shown in FIG. 4, or both.

The computer system 400 may also include other similar means for allowing computer programs or other instructions to be loaded. Such means can include, for example, a communications interface 416 which allows software and data to be transferred between the computer system 400 and external systems and networks. Examples of communications interface 416 can include a modem, a network interface such as an Ethernet card, a wireless communication interface, or a serial or parallel communications port. Software and data transferred via communications interface 416 are in the form of signals which can be electronic, acoustic, electromagnetic, optical or other signals capable of being received by communications interface 416. Multiple interfaces, of course, can be provided on a single computer system 400.

Input and output to and from the computer 406 is administered by the input/output (I/O) interface 418. This I/O interface 418 administers control of the display 402, keyboard 404A, external devices 408 and other such components of the computer system 400. The computer 406 also includes a graphical processing unit (GPU) 420. The latter may also be used for computational purposes as an adjunct to, or instead of, the (CPU) 410, for mathematical calculations.

The external devices 408 include a microphone 426, a speaker 428 and a camera 430. Although shown as external devices, they may alternatively be built in as part of the hardware of the computer system 400.

The various components of the computer system 400 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored in the memory 412 of the computer 406, or on a computer usable or computer readable medium external to the computer 406, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

### REFERENCES

The following list of references is provided for convenience only, and without admission that any of the references constitutes prior art or is relevant to the invention as claimed.
Josh Achiam, Steven Adler, Sandhini Agarwal, Lama Ahmad, Ilge Akkaya, Florencia Leoni Aleman, Diogo Almeida, Janko Altenschmidt, Sam Altman, Shyamal Anadkat, et al. 2023. Gpt-4 technical report. arXiv preprint arXiv:2303.08774.
Fernando Amat, Ashok Chandrashekar, Tony Jebara, and Justin Basilico. 2018. Artwork personalization at Netflix. In Proceedings of the 12th ACM Conference on Recommender Systems, pages 487-488.
Anthropic. 2024. Claude 3 haiku: our fastest model yet. https://www.anthropic.com/news/claude-3-haiku.
Lisa P Argyle, Ethan C Busby, Nancy Fulda, Joshua R Gubler, Christopher Rytting, and David Wingate. 2023. Out of one, many: Using language models to simulate human samples. Political Analysis, 31(3):337-351.
Kirk Bansak, Jens Hainmueller, Daniel J. Hopkins, and Teppei Yamamoto. 2021. Conjoint Survey Experiments, page 19-41. Cambridge University Press.
Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, et al. 2020. Language models are few-shot learners. Advances in Neural Information Processing Systems, 33:1877-1901.
Philippe Cattin and Dick R Wittink. 1982. Commercial use of conjoint analysis: A survey. Journal of Marketing, 46(3):44-53.
Wei Chu, Lihong Li, Lev Reyzin, and Robert Schapire. 2011. Contextual bandits with linear payoff functions. In Proceedings of the Fourteenth International Conference on Artificial Intelligence and Statistics, pages 208-214. JMLR Workshop and Conference Proceedings.
Hengchen Dai, Silvia Saccardo, Maria A Han, Lily Roh, Naveen Raja, Sitaram Vangala, Hardikkumar Modi, Shital Pandya, Michael Sloyan, and Daniel M Croymans. 2021. Behavioural nudges increase covid-19 vaccinations. Nature, 597(7876):404-409.
Miroslav Dudik, Katja Hofmann, Robert E Schapire, Aleksandrs Slivkins, and Masrour Zoghi. 2015. Contextual dueling bandits. In Conference on Learning Theory, pages 563-587. PMLR.
Wendy Netter Epstein, Christopher T Robertson, David Yokum, Hansoo Ko, Kevin H Wilson, Monica Ramos, Katherine Kettering, and Margaret Houtz. 2022. Can moral framing drive insurance enrollment in the United States? Journal of Empirical Legal Studies, 19(4):804-843.
Albert Q Jiang, Alexandre Sablayrolles, Arthur Mensch, Chris Bamford, Devendra Singh Chap-lot, Diego de las Casas, Florian Bressand, Gianna Lengyel, 2023. Mistral 7b. arXiv preprint arXiv:2310.06825
Robert Kleinberg, Alexandru Niculescu-Mizil, and Yogeshwer Sharma. 2010. Regret bounds for sleeping experts and bandits. Machine learning, 597 80(2):245-272.
Sarah Kreps, Sandip Prasad, John S Brownstein, Yulin Hswen, Brian T Garibaldi, Baobao Zhang, and Douglas L Kriner. 2020. Factors associated with us adults' likelihood of accepting covid-19 vaccination. JAMA network open, 3(10):e2025594-e2025594.
Douglas Kriner, Sarah Kreps, John S Brownstein, Yulin Hswen, Baobao Zhang, and Sandip Prasad. 2020. Replication Data for: Factors Associated With US Adults' Likelihood of Accepting COVID-19 Vaccination: Evidence From a Survey and Choice-Based Conjoint Analysis. https://dataverse.harvard.edu/dataset.xhtml?persistentId=doi:10.7910/DVN/6BSJYP
Lihong Li, Wei Chu, John Langford, and Robert E Schapire. 2010. A contextual-bandit approach to personalized news article recommendation. In Proceedings of the 19th International Conference on World Wide Web, pages 661-670.
Elizabeth Linos, Jessica Lasky-Fink, Chris Larkin, Lindsay Moore, and Elspeth Kirkman. 2024. The formality effect. Nature Human Behaviour, 8(2):300-310.
Jordan J Louviere. 1994. Conjoint analysis, pages 223-259. Blackwell Oxford.
Tyler Lu, Divid Pál, and Martin Pál. 2010. Contextual multi-armed bandits. In Proceedings of the Thirteenth international conference on Artificial Intelligence and Statistics, pages 485-492. JMLR Workshop and Conference Proceedings.
Nathaniel Rabb, Megan Swindal, David Glick, Jake Bowers, Anna Tomasulo, Zayid Oyelami, Kevin H Wilson, and David Yokum. 2022. Evidence from a statewide vaccination rct shows the limits of nudges. Nature, 604(7904):E1-E7.
Shibani Santurkar, Esin Durmus, Faisal Ladhak, Cinoo Lee, Percy Liang, and Tatsunori Hashimoto. 2023. Whose opinions do language models reflect? In International Conference on Machine Learning, pages 29971-30004. PMLR.
Gabriel Simmons. 2022. Moral mimicry: Large language models produce moral rationalizations tailored to political identity. arXiv preprint arXiv:2209.12106.
Richard H Thaler and Cass R Sunstein. 2021. Nudge: The final edition. Yale University Press.
Marta Trapero-Bertran, Beatriz Rodriguez-Martin, and Julio Löpez-Bastida. 2019. What attributes should be included in a discrete choice experiment related to health technologies? a systematic literature review. PloS one, 14(7):e0219905.
Chicheng Zhang, Alekh Agarwal, Hal Daumé Iii, John Langford, and Sahand Negahban. 2019. Warm-starting contextual bandits: Robustly combining supervised and bandit feedback. In International Conference on Machine Learning, pages 7335-7344. PMLR.
Wayne Xin Zhao, Kun Zhou, Junyi Li, Tianyi Tang, Xiaolei Wang, Yupeng Hou, Yingqian Min, Beichen Zhang, Junjie Zhang, Zican Dong, et al. 2023. A survey of large language models. arXiv preprint arXiv:2303.18223.
Tor Lattimore and Csaba Szepesviri. 2020. Bandit algorithms, pages 238-240. Cambridge University Press.
Hamsa Bastani, Mohsen Bayati, and Khashayar Khosravi. 2021. Mostly exploration-free algorithms for contextual bandits. Management Science, 67(3):1329-1349.
Maximilian Kasy and Anja Sautmann. 2021. Adaptive treatment assignment in experiments for policy choice. Econometrica, 89(1):113-132.

What is claimed is:

1. A computer-implemented method for initializing a contextual multi-armed bandit framework, the method comprising:
prompting a trained large language model (LLM) to generate a plurality of synthetic users each having a respective context, wherein each context comprises respective specified values for a plurality of features for the respective synthetic user;
specifying a plurality of arms for a contextual multi-armed bandit; and
using the LLM and the contexts of the respective synthetic users to pre-train the contextual multi-armed bandit.

2. The method of claim 1, wherein using the LLM and the contexts of the respective synthetic users to pre-train the contextual multi-armed bandit comprises:
for each one of at least a subset of the synthetic users, over at least one iteration, prompting the LLM to use the context to pretend to be that one of the synthetic users and to select a preferred arm; and
wherein for each arm in the plurality of arms, a reward for that arm and that user is calculated using a number of times the LLM pretending to be that one of the synthetic users selects that arm.

3. The method of claim 2, wherein the at least one iteration is a plurality of iterations.

4. The method of claim 2, wherein prompting the LLM to use the context to pretend to be that one of the synthetic users and to select a preferred arm for each ordered set comprises prompting the LLM to select from an ordered pair of the arms.

5. The method claim 1, wherein the context of each user is a textual embedding of the respective specified values.

6. The method of claim 1, wherein the respective specified values include at least one of age, gender, location, occupation, hobbies, and previous activities.

7. The method of claim 1, wherein the arms are specific to respective ones of the synthetic users.

8. The method of claim 7, wherein features of the arms are generated using the LLM based on the respective contexts of the respective ones of the synthetic users.

9. The method of claim 1, wherein the arms are fixed for all users.

10. A computer program product comprising at least one tangible, non-transitory computer-readable medium embodying instructions which, when executed by at least one processor of a data processing system, cause the data processing system to implement a method for initializing a contextual multi-armed bandit framework, the method comprising:
prompting a trained large language model (LLM) to generate a plurality of synthetic users each having a respective context, wherein each context comprises respective specified values for a plurality of features for the respective synthetic user;
specifying a plurality of arms for a contextual multi-armed bandit; and
using the LLM and the contexts of the respective synthetic users to pre-train the contextual multi-armed bandit.

11. The computer program product of claim 10, wherein using the LLM and the contexts of the respective synthetic users to pre-train the contextual multi-armed bandit comprises:
for each one of at least a subset of the synthetic users, over at least one iteration, prompting the LLM to use the context to pretend to be that one of the synthetic users and to select a preferred arm; and
wherein for each arm in the plurality of arms, a reward for that arm and that user is calculated using a number of times the LLM pretending to be that one of the synthetic users selects that arm.

12. The computer program product of claim 11, wherein prompting the LLM to use the context to pretend to be that one of the synthetic users and to select a preferred arm for each ordered set comprises prompting the LLM to select from an ordered pair of the arms.

13. The computer program product of claim 10, wherein the context of each user is a textual embedding of the respective specified values.

14. The computer program product of claim 10, wherein:
the arms are specific to respective ones of the synthetic users; and
features of the arms are generated using the LLM based on the respective contexts of the respective ones of the synthetic users.

15. A data processing system comprising memory and at least one processor coupled to the memory, wherein the memory contains instructions which, when executed by the at least one processor, cause the at least one processor to implement a method for initializing a contextual multi-armed bandit framework, the method comprising:
prompting a trained large language model (LLM) to generate a plurality of synthetic users each having a respective context, wherein each context comprises respective specified values for a plurality of features for the respective synthetic user;
specifying a plurality of arms for a contextual multi-armed bandit; and
using the LLM and the contexts of the respective synthetic users to pre-train the contextual multi-armed bandit.

16. The data processing system of claim 15, wherein using the LLM and the contexts of the respective synthetic users to pre-train the contextual multi-armed bandit comprises:
for each one of at least a subset of the synthetic users, over at least one iteration, prompting the LLM to use the context to pretend to be that one of the synthetic users and to select a preferred arm; and
wherein for each arm in the plurality of arms, a reward for that arm and that user is calculated using a number of times the LLM pretending to be that one of the synthetic users selects that arm.

17. The data processing system of claim 16, wherein prompting the LLM to use the context to pretend to be that one of the synthetic users and to select a preferred arm for each ordered set comprises prompting the LLM to select from an ordered pair of the arms.

18. The data processing system of claim 15, wherein the context of each user is a textual embedding of the respective specified values.

19. The data processing system of claim 15, wherein:
the arms are specific to respective ones of the synthetic users; and
features of the arms are generated using the LLM based on the respective contexts of the respective ones of the synthetic users.
